(19) United States
(12) Patent Application Publication
(10) Pub. No.: US 2006/0269056 A1
(43) Pub. Date: Nov. 30, 2006

(54) Messaging interface for protected digital outputs

(76) Inventor: Bruce Montag, Austin, TX (US)

Correspondence Address: HAMILTON & TERRILE, LLP, P.O. BOX 203518, AUSTIN, TX, 78720, US

(21) Appl. No.: 11/132,589

(22) Filed: May 19, 2005

(51) Int. Cl. H04N 7/167; H04N 7/16

(52) U.S. Cl. 380/205; 725/31; 725/25; 380/200

(57) ABSTRACT

An apparatus and method for determining and displaying status messages relating to protected digital content control information conveyed between a transmitting device, and a receiving device capable of establishing a secured communication channel, through the use of protected input/output ports. The status messages can be presented to the user through a plurality of implementations, including a display control panel of a transmitting device or an on-screen display of a receiving device. The method of the invention can reduce potential confusion and frustration for the user, who might otherwise suspect an equipment malfunction, resulting in needless, time consuming, and costly support calls.

### BACKGROUND OF THE INVENTION

1. Field of the Invention

The present invention relates in general to the field of information handling systems management and deployment, and more specifically, to management and display of protected digital content control information.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

These advances have turned the vision of conveying high quality digital information, especially high definition video and audio content, to consumer devices into a reality. Consumers can now easily access high definition content when and where they want, whether through a personal computer (PC), a high definition TV (HDTV), a DVD player, a digital video recorder (DVR), or even portable devices.

Content owners are eager to take advantage of new business opportunities created by the use of these technologies across broad distribution channels, but they also want to ensure that their premium content is protected from unauthorized copying and redistribution. While existing digital rights management (DRM) and/or conditional access solutions protect digital content and enable business models in a closed network, they are not applicable in an open environment with many different types of consumer devices.

Currently, a number of content control solutions are either proposed or being implemented, including High-bandwidth Digital Content Protection (HDCP). Yet these solutions have attendant issues and none are currently capable of conveying content control status messages.

The HDCP specification is used to encrypt and protect digital video and audio signals transmitted between two HDCP-enabled devices using Digital Visual Interface (DVI) or High Definition Multimedia Interface (HDMI) connections. The sending device (e.g., a DVD player or HDTV tuner) encrypts the outgoing digital signal using the HDCP specification and a shared cryptographic key, and then conveys that signal via DVI or HDMI connection to the receiving device (e.g., an HDTV, etc.).

The receiving device then decodes the incoming signal using the HDCP standard, and uses the signal as allowed within its associated content control parameters. Note that the digital content itself does not include the HDCP encryption. Instead, encryption and decryption is performed by the connected HDCP-enabled devices themselves (e.g., HDTV tuner, HDTV, etc.).

However, the HDCP specification does not provides the ability to communicate status messages to the user, such as the display device's protected content control capabilities, status of digital certificates and/or keys used to protect content, and the content control mode currently in operation.

For example, when an HDCP transmitting device (e.g., HDTV tuner) is attached to a receiving device (e.g., HDTV), it attempts to send a digital signal to determine if the receiving device is HDCP-capable. If it is, the two devices will synchronize with each other and establish a secure digital connection. If the receiving device is not HDCP-capable, the transmitting device will not be able to establish an HDCP connection and the user will only see a blank screen or possibly a scrambled signal.

Such a scenario can easily confuse and frustrate a user, who might suspect an equipment malfunction, resulting in needless, time consuming, and costly support calls. Currently, no apparatus or method exists for a user to view content control information as status messages on a display.

### SUMMARY OF THE INVENTION

The method and apparatus of the present invention can determine control information associated with protected digital content and convey related status messages to a transmitting device's display control panel and/or a receiving device's On-Screen Display (OSD) for viewing by the user. Status information can include, but is not limited to, the display device's protected content control capabilities, status of digital certificates and/or keys used to protect content, and the content control mode currently in operation.

In one embodiment of the present invention, display of protected content, such as originating from digital cable broadcasts or high-definition media (e.g., Blu-ray DVDs), is controlled through the implementation of a secured connection between the protected digital display outputs of content transmitting devices (e.g., HDTV tuner) and the protected digital display inputs of content receiving devices (e.g., HDTV). The ability of a receiving device to display protected content is limited by the receiving device's support of protected digital display inputs.

Those knowledgeable in the art will realize that content protection systems for digital displays, such as High-bandwidth Digital Content Protection (HDCP), can provide such mechanisms, but fail to include provisions for conveying related status messages that the user can view on the display.

For example, there is no visible indication to the user whether a Digital Visual Interface (DVI) device contains logic to support HDCP. In this example, there are no means to visually confirm whether HDCP-protected content is displayable by the DVI device until an attempt is made to view the content. Further, if the DVI device does not support HDCP, the user may be presented with a blank screen or a scrambled signal. The user, confused and frustrated, might mistakenly suspect an equipment malfunction, resulting in needless, time consuming, and costly support calls.

In one embodiment of the invention, protected content control information would be sent by the display device driver, based on the state of the secured link as reported by the transmitting device in accordance with the protected digital output specification under implementation. In this embodiment, content protection mode, display device status, and other associated information would be conveyed to the display device using Display Data Channel/Command Interface (DDCI/CI), which is a Video Electronics Standards Association (VESA) standard for two-way communication between a host and a display over an Extended Distance Data Cable (EDDC) channel.

In one variation of this embodiment of the invention, the information is conveyed to the digital display through the use of Monitor Control Command Set (MCCS), a VESA standard that defines command codes that can be transmitted to a display using DDC/CI. MCCS v2 includes provisions for manufacturer-specific command codes. These manufacturer-specific command codes could be used to convey predetermined content protection information status messages to the digital display.

Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 illustrates one embodiment of a system for conveyance of protected digital content between digital content distributors and digital content consumers.

FIG. 3 is a generalized illustration of one embodiment of a system for the distribution of protected digital content to a content protection system.

FIG. 4 illustrates one embodiment of a digital content protection system.

FIG. 5 is a generalized illustration of one embodiment of the present invention as implemented in one embodiment of a digital content protection system.

FIG. 6 is a generalized illustration of one embodiment of the present invention for the display of protected digital content information on a display control panel or an on-screen display.

### DETAILED DESCRIPTION

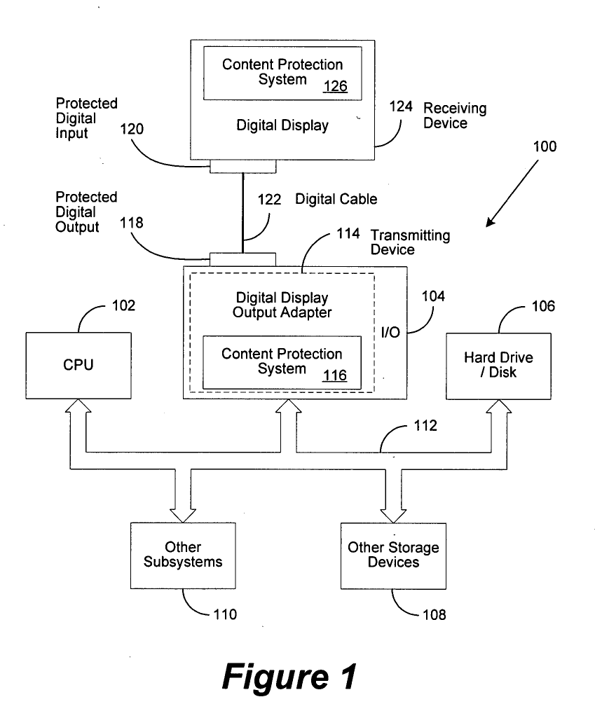

FIG. 1 is a generalized illustration of an information handling system 100 that can be used to implement the method and apparatus of the present invention. The information handling system includes a processor 102, input/output (I/O) devices 104, such as a display, a keyboard, a mouse, and associated controllers, a hard disk drive 106 and other storage devices 108, such as a floppy disk and drive and other memory devices, and various other subsystems 110, all interconnected via one or more buses 112.

In an embodiment of the present invention, I/O devices 104 include a transmitting device 114 (e.g., a digital display output adapter), comprising a digital content protection system 116, that can interact with a plurality of receiving devices 124 (e.g., a digital display), comprising a complementary digital content protection system 126, to create a secured channel for communication of protected digital content. As will be discussed in greater detail herein below, the secured channel can be established by implementing a connection between a protected digital output 118 of a transmitting device 114 through a digital cable 122, to a protected digital input 120 of a receiving device 120.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

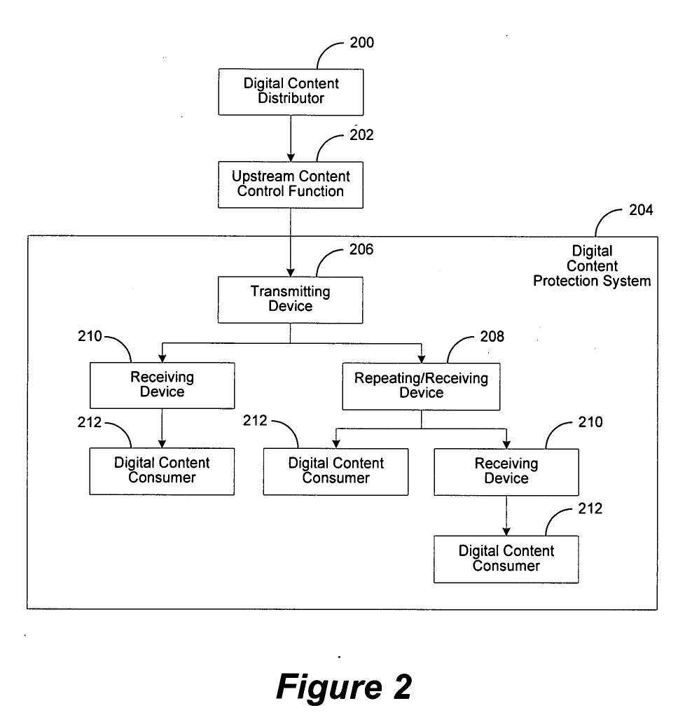

FIG. 2 is a general illustration of one embodiment of a system for conveyance of protected digital content between digital content distributors 200 and digital content consumers 212. In this embodiment, a digital content distributor implements an upstream content control function 202, which specifies and conveys the terms and conditions under which digital content can be utilized, to a content protection system 204. For example, these terms and conditions may include, but are not limited to, whether or not digital content can be copied, and if copying is allowed, how many times and at what resolution.

As described in more detail hereinbelow, a content protection system 204 is comprised of a plurality of transmitting devices 206, repeating/receiving devices 208, and receiving devices 210, which are used by digital content consumers 212.

In this embodiment, an upstream content control function conveys content control information to a transmitting device 206, which attempts to establish a secured connection with a receiving device 210, or a repeating/receiving device 208, which can establish secured connections with a plurality of downstream receiving devices 210, and validates that a receiving device 210 and/or repeating/receiving device is capable of establishing a secured connection. If a secured connection is established, protected digital content is conveyed to a digital content consumer 212 through a receiving device 210 or repeating/receiving device 208.

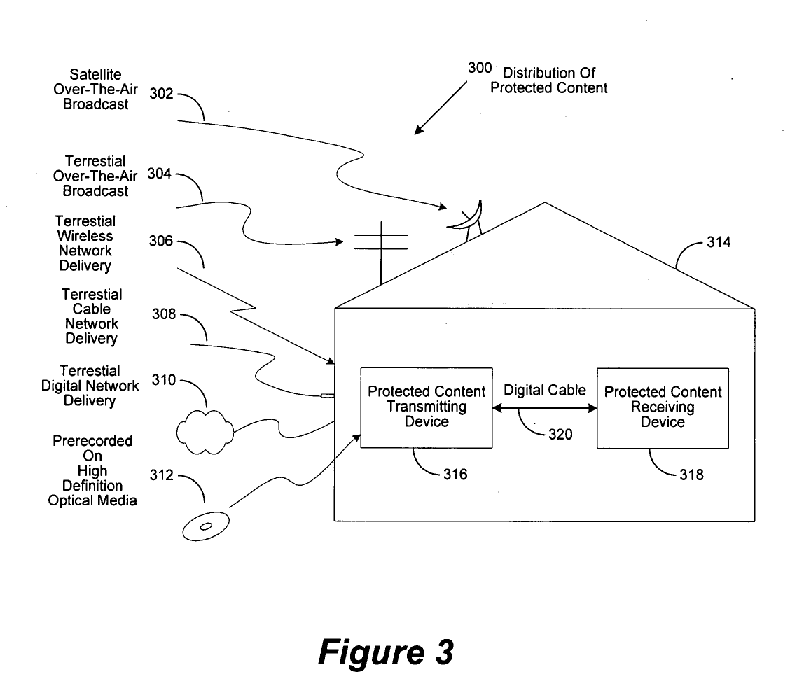

FIG. 3 is a generalized illustration of one embodiment of a system for the distribution of protected digital content 300 to a content protection system 312 (e.g., a consumer household).

In this embodiment, distribution of protected content 300 may be accomplished by a number of methods. For example, transmission through satellite broadcast 302, transmission through terrestrial over-the-air broadcast 304, transmission through wireless digital network 306, delivery through a terrestrial cable network 308, delivery through a terrestrial digital network 310, or delivery through prerecorded optical media. Those knowledgeable in the art will recognize that the examples referenced hereinabove are not all-inclusive and that many other methods, including combinations of, and extensions to, the examples referenced are possible.

In this embodiment, regardless of the distribution method implemented, protected digital content 300, with its associated content control information, is conveyed to a protected content transmitting device 316, which establishes a secured digital connection with a protected content receiving device 318, through a digital cable 320.

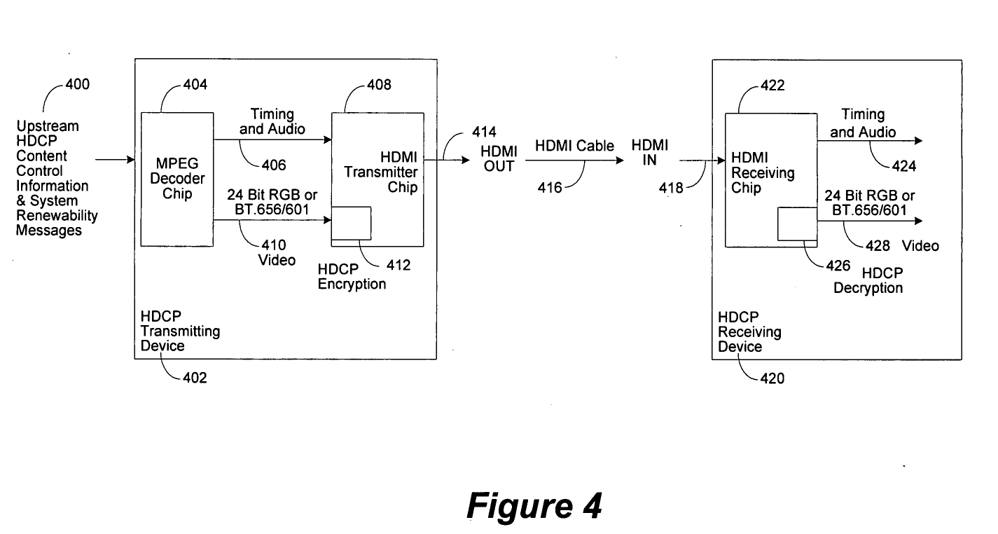

FIG. 4 is a generalized illustration of one embodiment of a digital content protection system. Protected digital content, combined with High-bandwidth Digital Copy Protection (HDCP) content control information and system renewability messages 400, explained in more detail hereinbelow, are conveyed to an HDCP transmitting device 402, as illustrated in lesser detail in FIGS. 2 and 3.

The HDCP transmitting device 402, comprising but not limited to, a Motion Pictures Expert Group (MPEG) decoder chip 404 and a High Definition Multimedia Interface (HDMI) transmitter chip 408, convey protected digital content through a protected digital output port 414.

Protected digital content and related control information 400 is routed through an MPEG decoder chip 404, which decodes the content stream into timing and audio signals 406 and video signals 410 (e.g., 24 bit RGB or BT.656/601), which are in turn routed to an HDMI transmitter chip 414. In this embodiment, content control information is HDCP-encrypted 412 within the HDMI transmitting chip 408. The resulting HDCP-encrypted content stream is then routed to a protected digital output 414, which is connected to an HDMI digital cable 416, which in turn is connected to a protected digital input 418 of an HDCP receiving device 420.

Once the HDCP-encrypted content stream is received by the protected digital input 418, it is routed to an HDMI receiving chip 422. In this embodiment, the HDCP-encrypted content stream is decoded by an HDCP encryption capability 426 into timing and audio signals 424 and video signals 428 (e.g., 24 bit RGB or BT.656/601), which are used by the HDCP receiving device for video and audio presentation to the user.

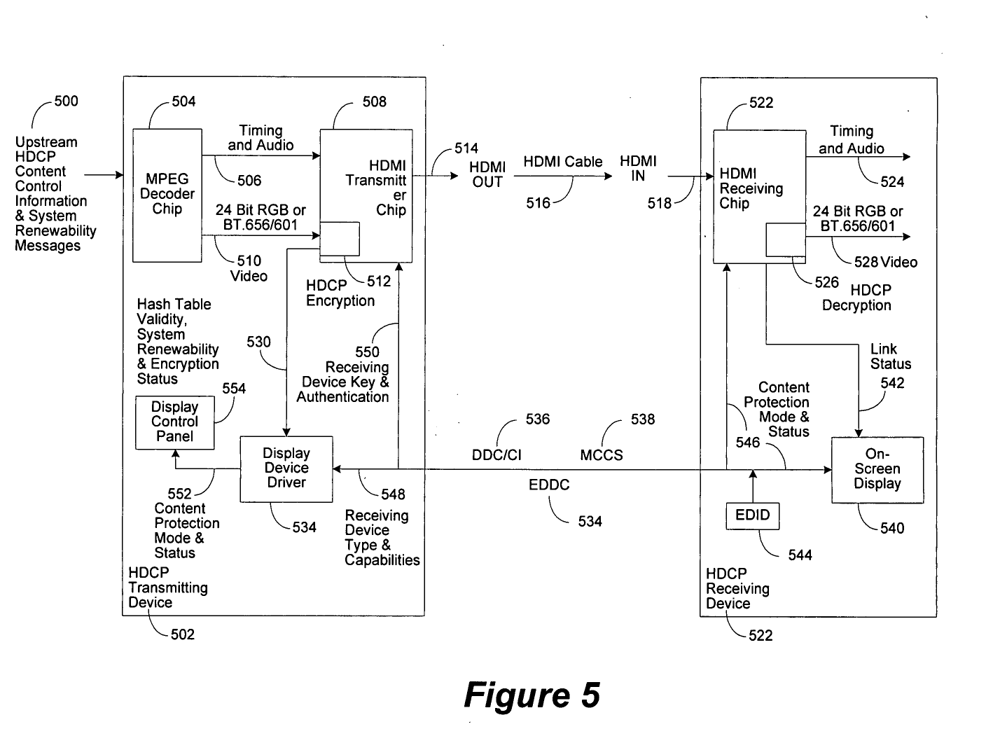

FIG. 5 is a generalized illustration of one embodiment of the present invention as implemented in one embodiment of a digital content protection system. Protected digital content, combined with HDCP content control information and system renewability messages 500, explained in more detail hereinbelow, are conveyed to an HDCP transmitting device 502, as illustrated in lesser detail in FIGS. 2, 3 and 4.

Experienced practitioners of the art will be educated in the fact that HDCP, when layered on top of HDMI, creates a secured connection between the protected outputs of an HDCP transmitting device and the protected inputs of an HDCP receiving device.

The current HDCP specification describes a three-phase authentication and key-exchange procedure that requires each device to be identified by a secret 40 bit Key Selection Vector (KSV) and an array or forty, secret 56 bit device keys. Each bit in the KSV corresponds to one of the forty device keys. Each HDCP-compliant transmitting, repeating/receiving, and receiving device permanently stores both of these data elements in a secure, internal location.

HDCP also describes a renewability function that automatically excludes unauthorized devices through the use of system renewability messages. In this embodiment of the invention, assuming that all involved devices are proven to be valid when checked against the current system renewability message, the stored data elements are used in a series of key exchanges and cryptographic operations takes place to authenticate all involved HDCP devices to one another.

Once the devices are confident of each other's integrity and authenticity, the HDCP transmitting device 502, comprising but not limited to, an MPEG decoder chip 504 and an HDMI transmitter chip 508, can begin conveying protected digital content through a protected digital output port 514. Protected digital content and related control information 500 is routed through an MPEG decoder chip 504, which decodes the content stream into timing and audio signals 506 and video signals 510 (e.g., 24 bit RGB or BT.656/601), which are in turn routed to an HDMI transmitter chip 514. In this embodiment, content control information is HDCP-encrypted 512 within the HDMI transmitting chip 508.

The resulting HDCP-encrypted content stream is then routed to a protected digital output 514, which is connected to an HDMI digital cable 516, which in turn is connected to a protected digital input 518 of an HDCP receiving device 520. Once the HDCP-encrypted content stream is received by the protected digital input 518, it is routed to an HDMI receiving chip 522. In this embodiment, the HDCP-encrypted content stream is decoded by an HDCP decryption capability 526 into timing and audio signals 524 and video signals 528 (e.g., 24 bit RGB or BT.656/601), which are used by the HDCP receiving device for video and audio presentation to the user.

However, in this embodiment, the status of these data elements, and related renewability messages, cannot be displayed without implementing the present invention.

Those accomplished in the art are knowledgeable of Display Data Channel/Command Interface (DDC/CI), a VESA (Video Electronics Standards Association) standard for two-way communication between a host and a display over an EDDC (Extended Distance Data Cable) channel. Skilled practitioners of the art will be equally knowledgeable of Monitor Control Command Set v2 (MCCS v2), a complimentary VESA standard that defines command codes, including provisions for manufacturer-specific command codes, which are transmitted to the display using DDC/CI. Those highly informed in the art will also be educated regarding Extended Display Identification Data (EDID), a VESA standard data format containing basic information about a display device and its capabilities including, but not limited to, vendor information, maximum image size, color characteristics, factory pre-set timings, frequency range limits, and character strings for the monitor name and serial number.

EDID information is stored in the display and is used to communicate with the host through DDC/CI, described in more detail hereinabove, which resides between the digital display receiving device and the transmitting device.

In this embodiment of the invention, capabilities of DDC/CI 536 and MCCS 538 are used in conjunction to convey EDID 544 information comprising receiving device type and capabilities 548 combined with related link status 542, and content protection mode status messages 552 to display device driver 534 which can be presented via display control panel 554 of transmitting device 502.

Concurrently, receiving device key and authentication is conveyed to HDMI transmitter chip 512, which interacts with HDCP encryption 512 capabilities to return cryptographic hash validation, system renewability and encryption status 530 to display device driver 534. This information can be directly presented to display control panel 554 of HDCP transmitting device 502 by display device driver 534, or through combined capabilities of DDC/CI 536 and MCCS 538 used in conjunction with EDDC channel 534, to on-screen display 540 of HDCP receiving device 522.

Conversely, display device driver 534 can convey cryptographic hash validation, system renewability and encryption status 530 messages combined with content protection mode and status messages 546 via combined capabilities of DDC/CI 536 and MCCS 538 used in conjunction with EDDC channel 534, for concurrent presentation to HDMI receiving chip 522 and on-screen display (OSD) 540 of HDCP receiving device 522.

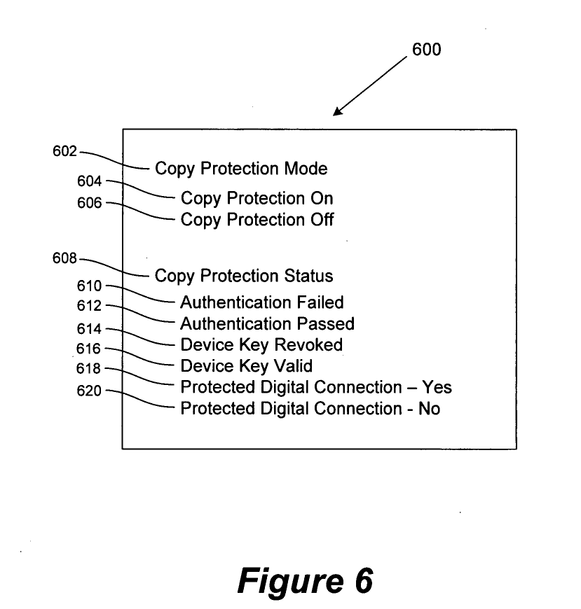

FIG. 6 is a generalized illustration of one embodiment of the present invention for the display of protected digital content information on a display control panel 600 or an on-screen display 600. In this embodiment, the copy protection mode 602 that is in use is displayed. For example, copy protection “On” 604 or copy protection “Off” 606 could be displayed. In this same embodiment, copy protection status 608 can be displayed. For example, authentication “Failed” 610 or authentication “Passed” 612 could be displayed. Similarly, device key “Revoked” 614 or device key “Valid,” could be displayed, along with protected digital connection “Yes” 618 or protected digital connection “No”. Those who are knowledgeable in the art will recognize that many different and relevant messages can be displayed, in a variety of text or graphical modes, as well as the manner in which they are presented to the user.

Skilled practitioners in the art will recognize that many other embodiments and variations of the present invention, based on other digital content protection systems, including but not limited to, Content Protection for Recordable Media (CPRM), or Digital Transmission Content Protection (DTCP), are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

At a minimum, the present invention provides a method and apparatus for determining protected digital content control information including, but not limited to, a display device's copy control capabilities, content protection key status, and current content protection mode, and conveying related status messages within a content protection system, to a receiving device's on-screen display (OSD) and a transmitting device's graphics control panel for viewing by the user. Further, use of the present invention can reduce potential confusion and frustration for the user, who might otherwise suspect an equipment malfunction, resulting in needless, time consuming, and costly support calls.

Although the present invention has been described in detail, it should be understood that various changes, substitutions and alterations can be made hereto without departing from the spirit and scope of the invention as defined by the appended claims.

What is claimed is:

1. A system for providing information relating to digital content, comprising:
an information handling system operable to generate a protected digital content signal and control information associated with said protected digital content signal; and
a display operable to receive said protected digital content signal and said associated control information, said display further being operable to use said control information to display status information relating to said protected digital content signal.

2. The system of claim 1, wherein said display device comprises an on-screen display.

3. The system of claim 1, wherein said display device comprises a control panel.

4. The system of claim 1, wherein said display provides status information relating to the display's content control capabilities.

5. The system of claim 1, wherein said display provides status information relating to a content key status.

6. The system of claim 1, wherein said display provides status information relating to a current content protection mode.

7. The system of claim 1, wherein said control information is provided over a secure communication channel.

8. The system of claim 7, wherein said associated control information is provided in accordance with an Extended Distance Data Cable (EDDC) channel.

9. The system of claim 8, wherein said associated control information is provided in accordance with a Display Data Channel/Command Interface (DDC/CI).

10. The system of claim 8, wherein said associated control information is provided in accordance with a Monitor Control Command Set (MCCS).

11. The system of claim 8, wherein said associated control information is provided in accordance with Extended Display Identification Data (EDID).

12. A method for providing information relating to digital content, comprising:
using an information handling system to generate a protected digital content signal and control information associated with said protected digital content signal; and
receiving said protected digital content signal and said associated control information in a display, said display being operable to use said control information to display status information relating to said protected digital content signal.

13. The method of claim 12, wherein said display comprises an on-screen display.

14. The method of claim 12, wherein said display device comprises a control panel.

15. The method of claim 12, wherein said display provides status information relating to the display's content control capabilities.

16. The method of claim 12, wherein said display provides status information relating to a content key status.

17. The method of claim 12, wherein said display provides status information relating to a current content protection mode.

18. The method of claim 12, wherein said control information is provided over a secure communication channel.

19. The method of claim 18, wherein said associated control information is provided in accordance with an Extended Distance Data Cable (EDDC) channel.

20. The method of claim 19, wherein said associated control information is provided in accordance with a Display Data Channel/Command Interface (DDC/CI).

21. The method of claim 19, wherein said associated control information is provided in accordance with a Monitor Control Command Set (MCCS).

22. The method of claim 19, wherein said associated control information is provided in accordance with Extended Display Identification Data (EDID).
